(19) United States
(12) Patent Application Publication
(10) Pub. No.: US 2015/0236466 A1
(43) Pub. Date: Aug. 20, 2015

(54) CIRCUIT BREAKOUT ASSEMBLY PROCESS

(71) Applicant: Peterson Manufacturing Company, Grandview, MO (US)

(72) Inventors: David Shaw Armacost, Leawood, KS (US); Robert Brumback, Waverly, MO (US); Rhett Peterson, Independence, MO (US)

(73) Assignee: Peterson Manufacturing Company, Grandview, MO (US)

(21) Appl. No.: 14/625,456

(22) Filed: Feb. 18, 2015

Related U.S. Application Data
(60) Provisional application No. 61/941,180, filed on Feb. 18, 2014.

(51) Int. Cl. H01R 43/20

(52) U.S. Cl. CPC H01R 43/205

(57) ABSTRACT

Implementations described and claimed herein provide apparatuses, systems, and methods for creating circuit breakouts within a molded harness to provide electrical energy to several connection points from a single energy source connection point. In one implementation, a component group wire configured to supply electrical power from a source to a component group including a set of target components is terminated. The terminated component group wire is connected to an input terminal of a printed circuit board. The input terminal corresponds to a breakout circuit for the component group. A plurality of component wires are terminated. Each of the component wires correspond to a component in the set of target components. Each of the terminated component wires are connected to an output terminal in the breakout circuit for the component group. The output terminals are electrically connected to the input terminal with conducting traces embedded into the printed circuit board.

### CROSS-REFERENCE TO RELATED APPLICATIONS

The present application claims benefit under 35 U.S.C. §119(e) to U.S. Provisional Patent Application No. 61/941,180, entitled “Circuit Breakout Assembly Process” and filed on Feb. 18, 2014, which is specifically incorporated by reference herein in its entirety.

### FIELD OF THE DISCLOSURE

Aspects of the present disclosure relate to circuit breakouts and more particularly to circuit breakouts providing electrical energy to several connection points from a single energy source connection point.

### BACKGROUND

Trailer vehicles are often utilized to transport freight, vehicles, or other items by connecting one or more unpowered trailers to a towing vehicle. For example, semi-trucks are large vehicles involving a towing vehicle pulling one or more semi-trailers. During transport, various vehicle lights should be visible to other drivers. Such vehicle lights displayed by the towing vehicle, however, are generally obscured by the trailer. As such, because the trailer is unpowered, the trailer must be electrically connected to the towing vehicle to provide visible, working lights, among other functions. Vehicle systems, such as running lights, brake lights, turn indicators, antilock braking systems (ABS), and other systems operating on a trailer, are thus powered and controlled by the towing vehicle.

Generally, electrical power is supplied to the various trailer systems via a single cable running from the towing vehicle. Circuit breakouts for each of the trailer systems may be created by soldering the incoming wire of the cable to wires running to each of the components of the trailer systems. Conventionally, the creation of circuit breakouts involves splicing several wires together by stripping insulation from the ends of the wires and soldering the wires together. The difficulties of this cumbersome soldering process are further exacerbated where a circuit breakout supplies a source electrical energy to several connection points.

It is with these observations in mind, among others, that various aspects of the present disclosure were developed.

### SUMMARY

Implementations described and claimed herein address the foregoing problems, among others, by providing systems, methods, and apparatuses for creating circuit breakouts within a molded harness to provide electrical energy to several connection points from a single energy source connection point. In one implementation, a component group wire configured to supply electrical power from a source to a component group including a set of target components is terminated. The terminated component group wire is connected to an input terminal of a printed circuit board. The input terminal corresponds to a breakout circuit for the component group. A plurality of component wires are terminated. Each of the component wires correspond to a component in the set of target components. Each of the terminated component wires are connected to an output terminal in the breakout circuit for the component group. The output terminals are electrically connected to the input terminal with one or more conducting traces embedded into the printed circuit board.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 illustrates an example printed circuit board providing a single to multi-connector circuit.

FIG. 2 shows an example printed circuit board wire assembly providing a single to multi-connector circuit.

FIG. 3 depicts an example molded assembly enclosing a printed circuit board wire assembly providing a single to multi-connector circuit.

FIG. 4 is a schematic diagram of an example printed circuit board providing a single to multi-connector circuit.

FIG. 5 is a schematic diagram of an example printed circuit board wire assembly providing a single to multi-connector circuit.

FIG. 6 illustrates example operations for creating circuit breakouts within a molded assembly.

### DETAILED DESCRIPTION

Aspects of the present disclosure involve systems, methods, and apparatuses for creating circuit breakouts within a molded harness to provide electrical energy to several connection points from a single energy source connection point. Generally, a Printed Circuit Board (PCB) wire assembly is created by connecting terminated wires into a PCB, which includes built-in traces manufactured from a highly conductive material to electrically connect a single source connection point to one or more components. The PCB wire assembly thus provides a single to multi-conductor circuit with in-line circuit intelligence, formed with without soldering. Protective material, such as plastic, is molded around the PCB wire assembly to form a harness providing protection for the PCB wire assembly, as well as installation convenience when electrically connecting a trailer to a towing vehicle for transport.

In one aspect, each wire connected to a component on a trailer is terminated and grouped according to component type. Each of the terminated wires in a group is attached to a designated connection point on a PCB. Source wires extending from a towing vehicle are each terminated and attached to an assigned source terminal on the PCB. The source wires provide an electrical connection from the towing vehicle to power and/or control the various components on the trailer. Conductive traces built into the PCB electronically connect a source terminal to one or more corresponding component terminals, thereby forming a breakout circuit.

Each breakout circuit distributes electrical power to multiple outputs from a single source emanating from a towing vehicle. For example, a towing vehicle of a semi-truck may provide a single source for powering various components of a trailer, including, without limitation, clearance markers, identification lights, tail lights, turn indicators, brake lights, ABS, and/or the like, as well as provide a ground return. Generally, the towing vehicle supplies power for the various trailer components using a power wire for each of the components and a single common wire for ground. Stated differently, as a trailer generally includes many clearance markers around the periphery of the trailer, multiple tail lights, and separate indicator lights and brake lights, for example, the breakout circuits connect each power wire to each component, which is also connected to ground.

The various systems, apparatuses, and methods disclosed herein generally provide for the creation of a single to multi-conductor circuit using a PCB. The example implementations discussed herein reference a molded circuit breakout assembly for providing an electrical connection between a towing vehicle and a towed vehicle. However, it will be appreciated by those skilled in the art that the presently disclosed technology is applicable to other electrical connections.

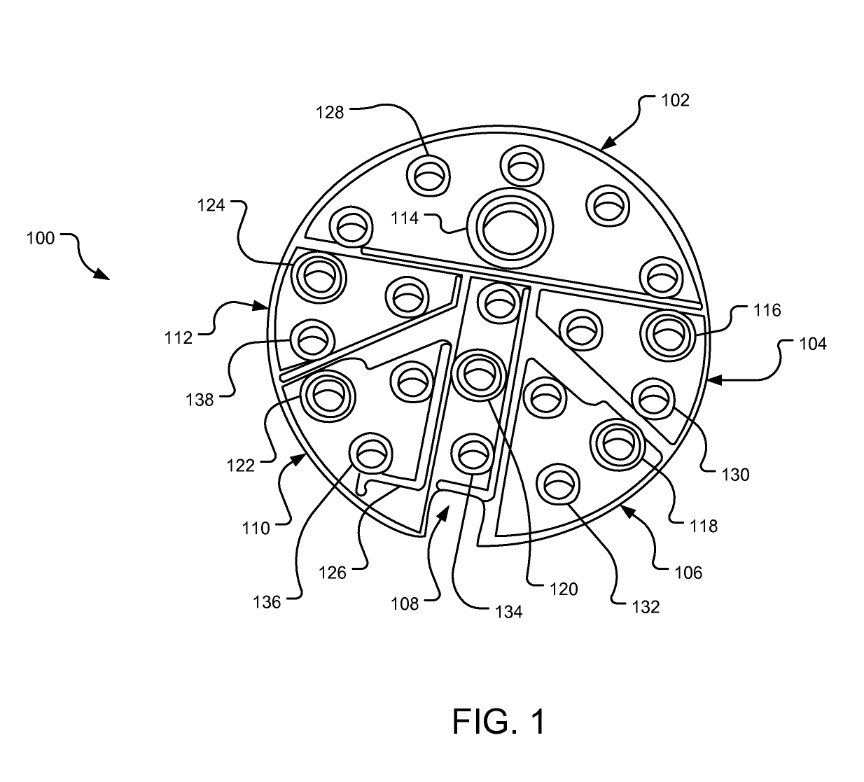

To begin a detailed description of an example PCB 100 providing a single to multi-connector circuit, reference is made to FIG. 1. In one implementation, the PCB 100 includes a surface configured to mechanically support and electrically connect a towing vehicle to a trailer. The surface of the PCB 100 is a non-conductive substrate, which may have a variety of sizes and shapes, including, but not limited to, circular, elliptical, rectangular, triangular, angled, contoured, or the like. In one implementation, the surface of the PCB 100 is planar with various electronic components laminated onto or otherwise built into the non-conductive substrate.

As can be understood from FIG. 1, in one implementation, the PBC 100 includes a plurality of breakout circuits, each of the breakout circuits corresponding to a component group operating on a trailer. Such component groups may include, without limitation, clearance markers, identification lights, tail lights, turn indicators, brake lights, ABS, and the like. In the example shown in FIG. 1, the PCB 100 includes six breakout circuits 102-112. However, it will be appreciated by those skilled in the art that additional or fewer breakout circuits may be included in the PCB 100.

Each of the breakout circuits 102-112 includes an input terminal configured to accept a terminated wire from the towing vehicle corresponding to a component group. For example, as shown in FIG. 1, a first breakout circuit 102 includes a first input terminal 114, a second breakout circuit 104 includes a second input terminal 116, a third breakout circuit 106 includes a third input terminal 118, a fourth breakout circuit 108 includes a fourth input terminal 120, a fifth breakout circuit 110 includes a fifth input terminal 122, and a sixth breakout circuit 112 includes a sixth input terminal 124.

In one implementation, the PCB 100 includes conductive traces (e.g., trace 126) embedded into the non-conductive substrate to provide electrical pathways between the input terminals 114-124 and corresponding output terminals within the breakout circuits 102-112, thereby providing a single power signal to multiple outputs for a component group. For example, in the implementation shown in FIG. 1, the first input terminal 114 is electrically connected to a first set of output terminals 128, the second input terminal 116 is electrically connected to a second set of output terminals 130, the third input terminal 118 is electrically connected to a third set of output terminals 132, the fourth input terminal 120 is electronically connected to a fourth set of output terminals 134, the fifth input terminal 122 is electronically connected to a fifth set of output terminals 136, and the sixth input terminal 124 is electronically connected to a fifth set of output terminals 138. Each of the sets of output terminals 128-138 is configured to provide power to a component group of the trailer. For example, the second set of output terminals 130 may provide power to the various tail lights on the trailer.

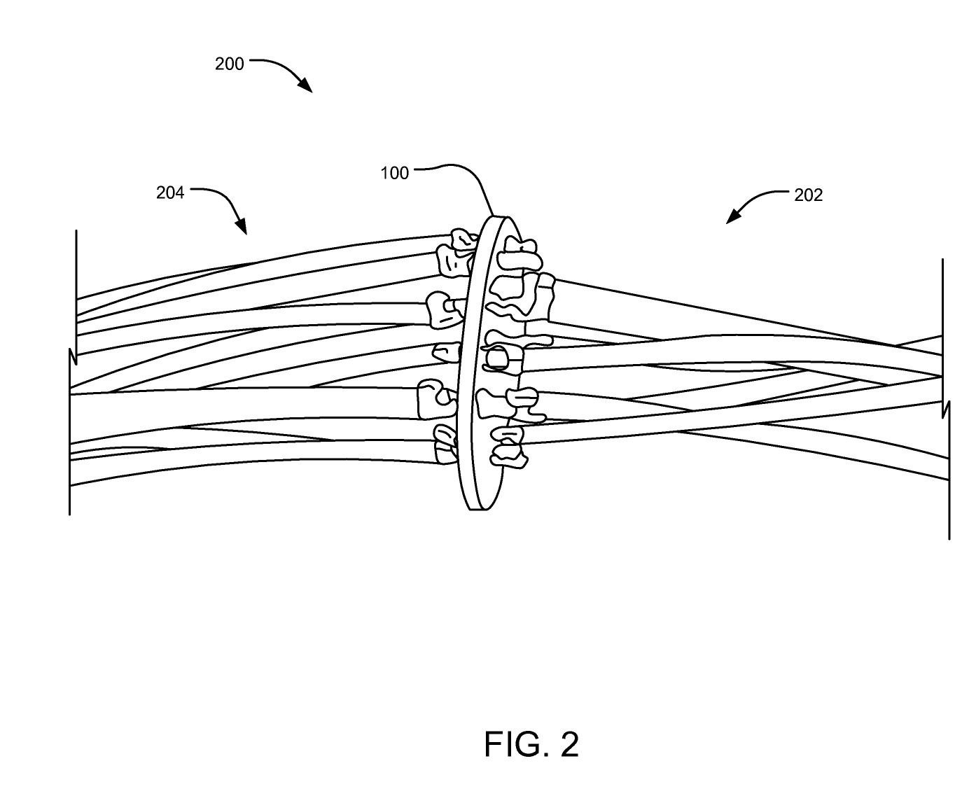

Turning to FIG. 2, an example PCB wire assembly 200 is shown. In one implementation, source wires 202 from the towing vehicle are terminated and attached to the PCB 100. The source wires 202 each provide power for a component group (e.g., tail lights). The source wires 202 may further include a relatively larger gauged ground wire. Each of the terminated source wires 202 are attached to an assigned input terminal 114-124 corresponding to the component group. For example, the terminated source wire for tail lights is attached to the input terminal corresponding to tail lights. Component wires 204 from the trailer are terminated and attached to corresponding output terminals 128-138 in the PCB 100 based on the component group. For example, each component wire 204 for one of the tail lights is connected to an output terminal within the breakout circuit electrically corresponding to tail lights.

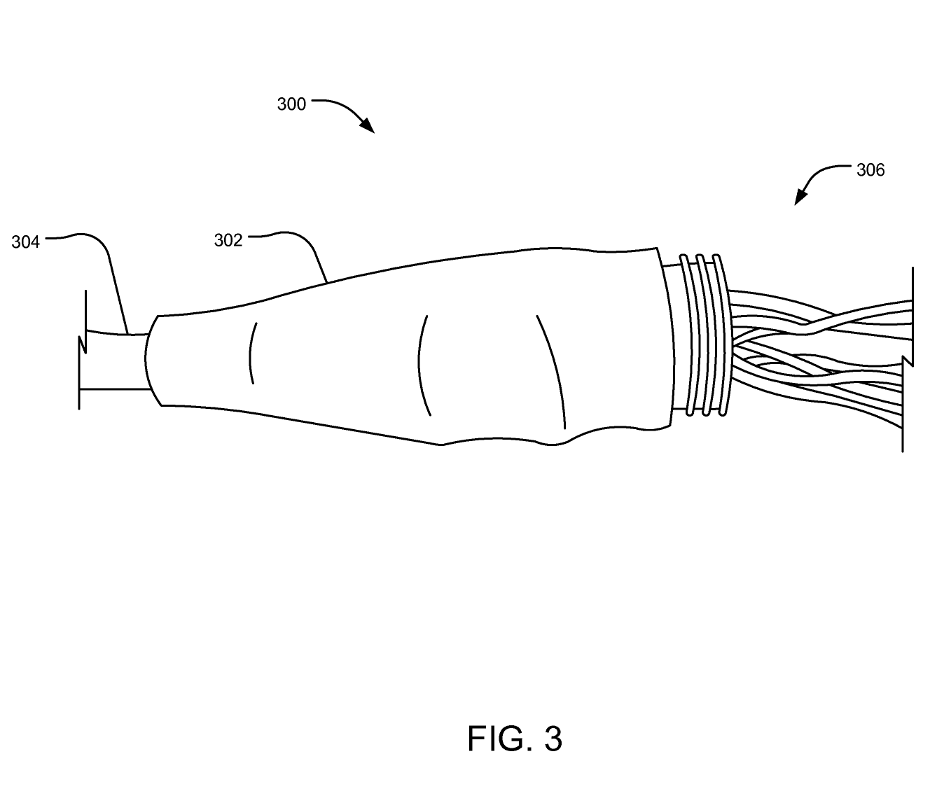

To protect the connection points of the PCB wire assembly 200, as well as facilitate installation for transporting a trailer using a towed vehicle, the PCB wire assembly 200 is provided with over-molded protection. Turning to FIG. 3, an example molded assembly 300 enclosing the PCB wire assembly 200 is shown. In one implementation a harness 302 is fitted, for example, via molding, around the PCB wire assembly 200. The harness 302 may be made from a variety of materials configured to protect the PCB wire assembly 200 from outside interference and/or degradation. For example, the harness 302 may be made from plastic, rubber, or the like. In one implementation, the molded assembly 300 includes a single cable 304 supplying power from a towing vehicle to various trailer components via a plurality of component wires 306. As shown in FIG. 3, the single cable 304 enters the harness 302, and the plurality of component wires 306 exit the harness 302 in the direction of the various trailer components.

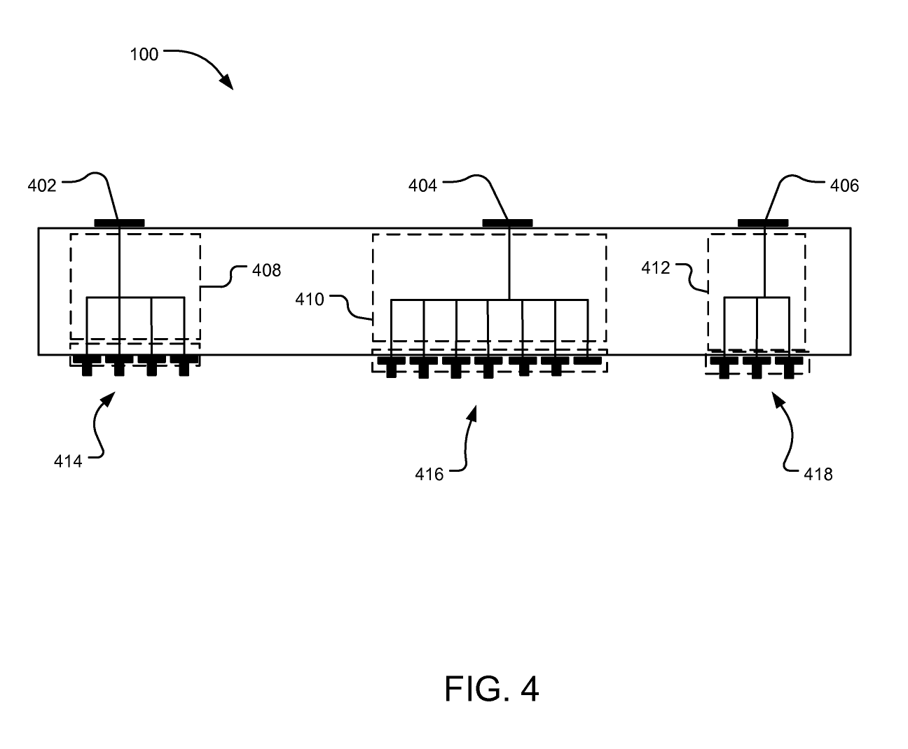

To continue the detailed description of the PCB 100, reference is made to FIG. 4, which shows a schematic diagram of the PCB 100. In one implementation, the PCB 100 facilitates a partial pre-wiring of spliced wires, thereby eliminating soldering of the wires by connecting terminated wires to the PCB 100 to create a breakout circuit.

The PCB 100 includes one or more input terminals (e.g., input terminals 402-406). Each of the input terminals 402-406 correspond to a breakout circuit (e.g., breakout circuits 408-412). For example, a first input terminal 402 corresponds to a first breakout circuit 408, a second input terminal 404 corresponds to a second breakout circuit 410, and a third input terminal 406 corresponds to a third breakout circuit 412.

In one implementation, the PCB 100 includes conductive traces embedded therein to connect each input terminal 402-406 with corresponding output terminals within the breakout circuits 408-412 to provide power to components associated with the breakout circuits 408-412. For example, the first breakout circuit 408 involves the single input terminal 402 connected to four output terminals 414. Similarly, the second breakout circuit 410 connects the second input terminal 404 to seven output terminals 416, and the third breakout circuit 412 connects the third input terminal 404 with three output terminals 418.

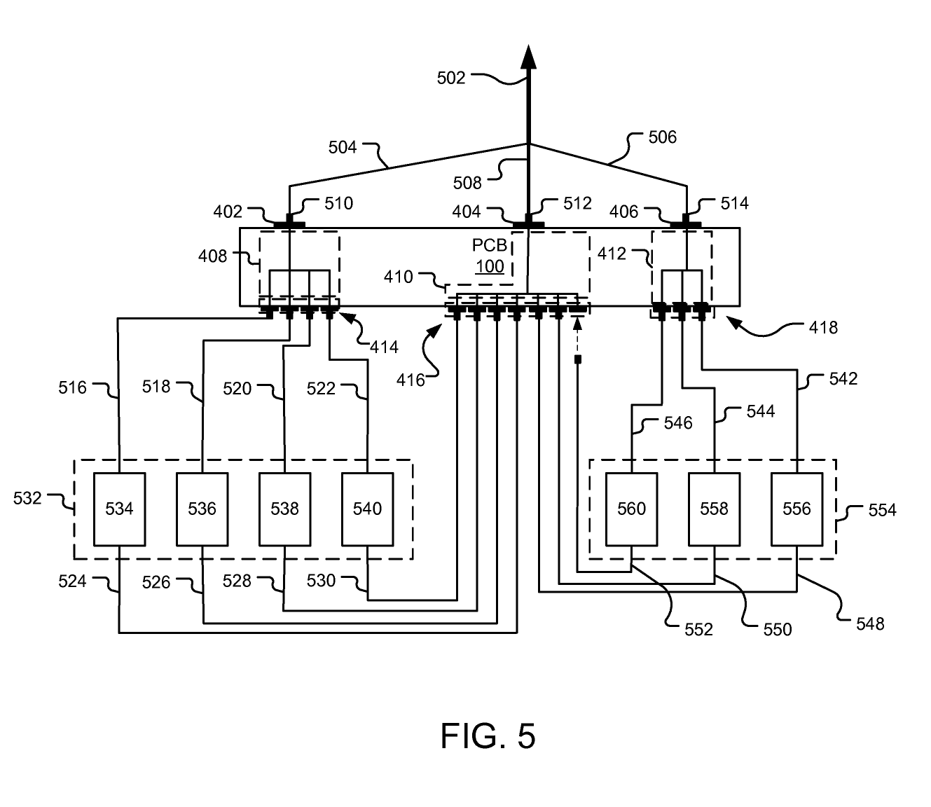

Turning to FIG. 5, in one implementation, a power cable 502 connected to a power source, for example, emanating from a towing vehicle, is received at a trailer for distributing power to multiple component groups in the trailer.

The power cable 502 includes one or more source wires corresponding to each component group operating on the trailer, as well as a common ground. For example, the power cable 102 may include six power lines to provide power for a trailer's clearance markers, ABS, tail lights, left and right turn signals, and brake lights, as well as a seventh wire for ground. Each of the source wires may be individually insulated and bundled together in an outer casing.

The PCB 100 is configured to receive each of the source wires included in the power cable 102 that will form a breakout circuit. In the example implementation shown in FIG. 5, the power cable 102 includes: a first component group wire 504, a second component group wire 506, and a ground wire 508. Each of the component group wires is configured to supply power to a corresponding component group of the trailer.

To facilitate the assembly process, in one implementation, the power wire 102 is stripped to reveal each of the component group wires 504 and 506 and the common ground 508. Each component wire 504 and 506 and the common ground 508 is terminated using a terminator 510, 514, and 512, respectively. The PCB 100 includes the input terminals 402-406 configured to accept the terminated source wires. For example, the first input terminal 402 is configured to accept the terminated component wire 504 via the terminator 510, the second input terminal 404 is configured to accept the terminated common ground wire 508 via the terminator 512, and the third input terminal 406 is configured to accept the terminated component wire 506 via the terminator 514. The wire terminators 510-514 and the input terminals 402-406 may include any type of wire terminator and terminals that are configured to work together.

In one implementation, the breakout circuits 408-412 of the PCB 100 provide power and ground connections via the cable 502 for a first component group 532, which includes a first set of components 534-540, and a second component group 554, which includes a second set of components 556-560. Each of the components 534-540 and 556-560 is connected to two wires, a component wire and a ground wire, as shown in FIG. 5. It will be appreciated that variations on the number of components and component groups are contemplated depending on the trailer components.

Stated differently, the first component group wire 504 supplies power for the first component group 532 and is broken out to connect the first breakout circuit 408 to a first set of component wires 516-522. Similarly, the second component group wire 506 powers the second component group 554 and is broken out by the third breakout circuit 412 to connect to a second set of component wires 542-546. The ground wire 508 is broken out by the second breakout circuit 410 and connects to the ground wire from each component. For example, a first set of ground wires 524-530 connect to the first component group 532, and a second set of ground wires 548-552 connect to the second component group 554.

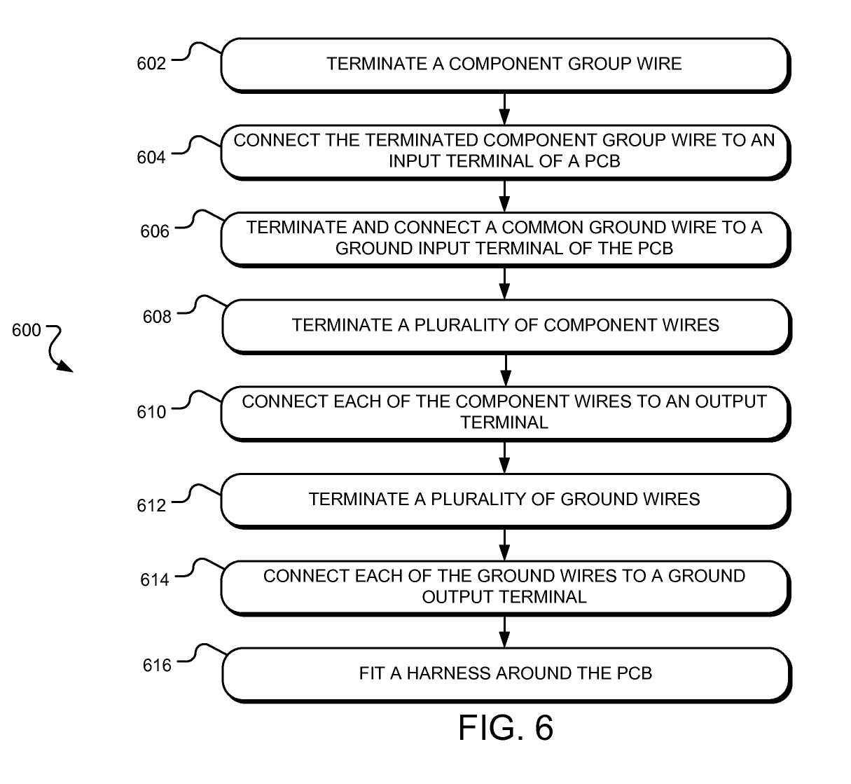

Referring to FIG. 6, example operations 600 for creating circuit breakouts within a molded assembly are illustrated. In one implementation, an operation 602 terminates a component group wire. The component group wire is configured to supply electrical power from a source, such as a towing vehicle, to a component group including a set of target components for a target, such as a trailer. The component group may be, without limitation, clearance markers, identification lights, tail lights, turn indicators, brake lights, ABS, and/or other target systems. In one implementation, an operation 604 connects the terminated component group wire to an input terminal of a PCB. The input terminal corresponds to a breakout circuit for the component group. The operations 602-604 may be repeated for additional component groups.

Similarly, in one implementation, an operation 606 terminates a common ground wire and connects the terminated common ground wire to a ground input terminal of the PCB. The ground input terminal corresponds to a ground breakout circuit.

An operation 608 terminates a plurality of component wires. Each of the component wires corresponds to a component in the set of target components. An operation 610 connects each of the terminated component wires to an output terminal in the breakout circuit for the component group. The output terminals are electrically connected to the input terminal in the breakout circuit for the component group with one or more conducting traces embedded into the PCB. The component wire thus is connected to plurality of component wires via the PCB to provide power from the source to the set of target components. The operations 608-610 may be repeated for additional component groups.

In one implementation, an operation 612 terminates a plurality of ground wires. Each of the ground wires corresponds to a component in the set of target components. An operation 614 connects each of the terminated ground wires to an output terminal in the ground breakout circuit. The output terminals are electrically connected to the input terminal in the ground breakout circuit with one or more conducting traces embedded into the PCB. The common ground wire thus is connected to plurality of ground wires via the PCB to provide ground from the source to the set of target components. In one implementation, to protect the PCB, an operation 616 fits a harness around the PCB, for example, via molding.

In the present disclosure, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure, as defined in the claims that follow.

What is claimed is:

1. A method for providing multipath electrical power, the method comprising:
terminating a component group wire configured to supply electrical power from a source to a component group including a set of target components;
connecting the terminated component group wire to an input terminal of a printed circuit board, the input terminal corresponding to a breakout circuit for the component group;
terminating a plurality of component wires, each of the component wires corresponding to a component in the set of target components; and
connecting each of the terminated component wires to an output terminal in the breakout circuit for the component group, the output terminals electrically connected to the input terminal with one or more conducting traces embedded into the printed circuit board.

2. The method of claim 1, wherein the source is a towing vehicle.

3. The method of claim 1, wherein the set of target components include trailer components.

4. The method of claim 1, wherein the component group corresponds to at least one of: clearance markers, identification lights, tail lights, turn indicators, brake lights, or an antilock braking system.

5. The method of claim 1, further comprising:
fitting a harness around the printed circuit board.

6. The method of claim 5, wherein the harness is fitted around the printed circuit board via molding.

7. The method of claim 1, further comprising:
terminating a common ground wire configured to provide a ground between the source and the set of target components.

8. The method of claim 7, further comprising:
connecting the terminated common ground wire to a ground input terminal of the printed circuit board, the ground input terminal corresponding to a ground breakout circuit.

9. The method of claim 8, further comprising:
terminating a plurality of ground wires, each of the ground wires corresponding to a component in the set of target components.

10. The method of claim 9, further comprising:
connecting each of the terminated ground wires to a ground output terminal in the ground breakout circuit, the ground output terminals electrically connected to the ground input terminal with one or more ground conducting traces embedded into the printed circuit board.
